(19) United States
(12) Patent Application Publication
(10) Pub. No.: US 2005/0108962 A1
(43) Pub. Date: May 26, 2005

(54) Method for making a microwave window and resulting window

(75) Inventor: Christophe Lievin, Fresnes (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: Thales, Neuilly Sur Seine (FR)

(21) Appl. No.: 10/511,909

(22) PCT Filed: Apr. 11, 2003
(86) PCT No.: PCT/FR03/01164

(30) Foreign Application Priority Data
Apr. 23, 2002 (FR) 02-05081

(51) Int. Cl. E06B 3/00

(52) U.S. Cl. 52/204.5

(57) ABSTRACT

The invention relates to a method of manufacturing a microwave window for the separation of media comprising a separating disk transparent to the electromagnetic microwaves and at least one collet in the form of a circular cylindrical tube brazed via of the two faces of the disk, characterized in that it includes at least one step consisting in depositing a thin film of active braze on that edge of the collet which is intended to be brazed onto one of the two faces of the disk, and then in brazing the tube onto the disk. The invention also relates to a media-separating microwave window resulting from the process, having at least one collet in the form of a circular cylindrical tube with a generatrix close to a straight line. Applications: high-power microwave tubes, microwave transmission lines.

The invention relates to a process for manufacturing a microwave window transparent to electromagnetic waves, ensuring that there is separation between two different media. Such windows are especially used in high-power microwave tubes or in transmission lines feeding a thermonuclear fusion machine.

FIG. 1 shows a diagram indicating the principle of such a very high-power microwave tube of the gyrotron type.

The gyrotron of FIG. 1 essentially comprises a chamber 10, in which a vacuum is created, and inside this chamber an electron gun 12 having a cathode 14 that delivers an electron beam 16, the electrons of which are accelerated by an anode 18. The electron beam 16 enters a resonant cavity 20 and then an injector 22 that generates an electromagnetic wave transmitted, after reflection by an electromagnetic mirror 24, through a microwave separating window 26 that separates the vacuum medium of the chamber 10 from the external ambient medium of the tube. The electron beam 16 is absorbed by a collector 28.

The separating window 26 must fulfill two main functions: firstly the separation between the vacuum inside the tube's chamber 10 and the external medium, which may be ambient air at atmospheric pressure, and, secondly, the transmission of the microwave toward the outside of the tube through this separating window. Consequently, the separating window must be capable of withstanding high mechanical stresses owing to the pressure difference between the two media—the vacuum medium inside the tube and the external medium at the pressure of the ambient air.

Furthermore, gyrotrons generate very high microwave power levels, of the order of 1 MW continuous-wave power, which generates high temperature-induced stresses in the separating window. A cooling circuit is provided for reducing the temperature of the window.

Such a tube generating very high continuous microwave power levels requires the creating of a very high vacuum in the chamber.

For this purpose, the manufacture of the tube includes a baking phase (lasting about 100 hours) followed by a conditioning phase. The duration of the conditioning phase depends on the maximum baking temperature of the tube, a higher baking temperature reducing the time needed to create the desired vacuum. The drawback of the microwave tubes of the prior art having a media-separating window is that the maximum baking temperature is limited by the temperature resistance of the window.

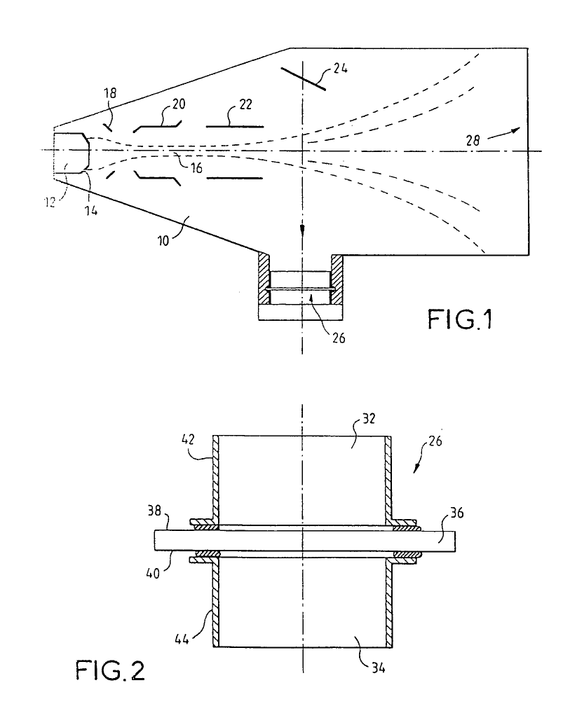

FIG. 2 shows the separating window 26 of the prior art used in the gyrotron of FIG. 1. The window 26 ensures that a first medium 32 is separated from a second medium 34, these media being, in the case of the gyrotron of FIG. 1, the inside of the chamber 10 and the outside of the tube.

The window 26 essentially comprises a cylindrical disk 36 having two plane faces 38 and 40 that separate the two media 32 and 34, a first collet 42 and a second collet 44, of circular cylindrical shape, which are fastened to the two respective plane faces of the disk. The first collet 42 mechanically fastens the window to the tube and ensures that the chamber 10 is sealed. The second collet 44 fastens the window (and the tube).

The disk 36 is made of a mechanically strong material in order to withstand the stresses due to the various pressure differences between the two media while allowing the electromagnetic wave generated by the gyrotron in the first medium to pass through the window, with the minimum of absorption, to the outside of the tube.

The disk 36 may be made of ceramic, sapphire, beryllium oxide or ultrapure alumina. For power levels reaching 1 MW, the disk 36 may be produced from synthetic diamond.

The metal collets are brazed onto the two faces of the disk.

The windows of the prior art have the drawback of their temperature limitation, which also limits the temperature at which the microwave tubes having this type of window are baked.

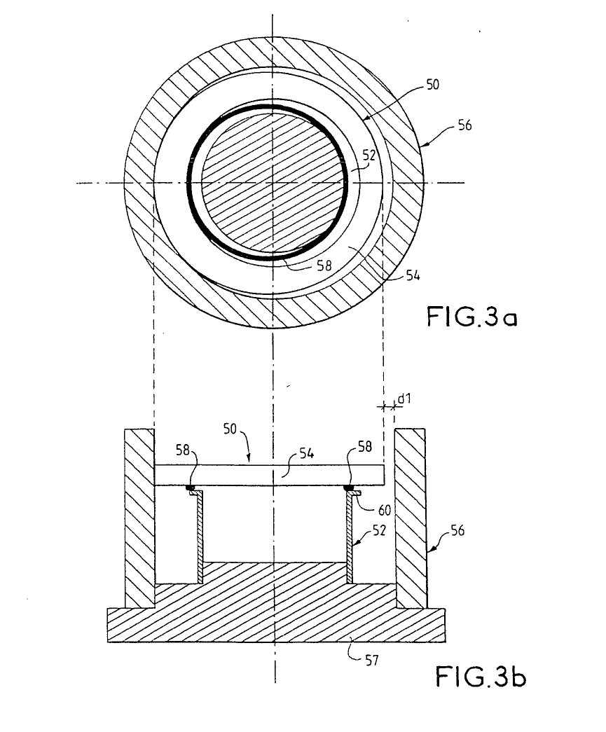

FIGS. 3a and 3b show respectively a top view and a sectional view of a separating window 50 of the prior art, during the operation of brazing a collet 52 onto a disk 54 of the window using a centering tool having a cylinder 56 and a base 57.

In a first step of the process for manufacturing the separating window 50 of the prior art, a bead of brazing metal 58 is deposited on the faces of the disk. The bead 58, in the form of a circular ring, has substantially the same width as the edge of the collet and the same diameter as the collet when it is hot during the brazing operation. In a next step, using the centering tool, the collet 52 is then brazed onto the bead 58.

The centering tool 56, 57 is designed to ensure that the collet 52 is in alignment with the bead 58 at the brazing temperature. The differences in expansion coefficients of the materials are therefore taken into consideration. The material of the cylinder 56 of the centering tool is chosen to have an expansion coefficient close to that of the disk 54, but a problem arises from the disk which has an extremely low expansion coefficient. At the brazing temperature of around 800° C., the disk is no longer perfectly guided by the centering tool, resulting in a misalignment dl between the disk and the collar that may be up to half the thickness of the collar. With such a method of the prior art, the reliability of the brazing is affected thereby.

To compensate for this offset, the collet 52 of circular cylindrical shape has, on the side facing the edge intended to be brazed onto the disk, a ring-shaped widening 60 that increases the surface area of the edge of the collet that faces the surface of the disk. This widening 60 is necessary owing to the gap d1 when positioning the collet on the disk. This gap is produced as the collet/disk assembly, positioned beforehand in the centering tool, rises in temperature. The drawback of this widening 60 is that the stresses between the disk and the collet when the assembly is cold increase, with the risk of the disk fracturing or of the seal between the collet and the disk breaking.

The main objective of the invention is to be able to use a higher baking temperature than that possible in the prior art for baking vacuum microwave electronic devices that include a media-separating microwave window, such as gyrotrons.

Another objective of this invention is to create a higher vacuum in such tubes, while still having a shorter baking time.

Other objectives of this invention are: to make the microwave window simpler to manufacture, to reduce its cost and give it better mechanical resistance at high temperatures.

For this purpose, and to alleviate the drawbacks of the prior art, the invention proposes a method of manufacturing a microwave window for the separation of media, comprising a separating disk transparent to the electromagnetic microwaves and at least one collet in the form of a circular cylindrical tube brazed via one of its edges onto one of the two faces of the disk, characterized in that it includes at least one step consisting in depositing a thin film of active braze on that edge of the collet which is intended to be brazed onto one of the two faces of the disk, and then in brazing the tube onto the disk.

One of the main features of the process for manufacturing the window according to the invention lies in the fact that an active braze is firstly deposited on the edge of the collet intended to be brazed onto the disk and not beforehand on the surface of the disk, unlike in the processes for brazing the windows of the prior art in which the circular bead of the same shape as the surface of the collet to be brazed is firstly brazed onto the surface of the disk before the disk is brazed onto the tube.

A first advantage of the process according to the invention lies in the fact that an offset between the braze bead and the edge of the tube no longer occurs owing to the fact that the bead of brazing material is deposited beforehand on the edge of the tube.

One practical consequence of the brazing process according to the invention is that, since the offset between the tube and the braze bead has been eliminated, the uniformity of the braze joint increases the reliability of the mechanical resistance between the disk and the brazed collet.

The invention also relates to a microwave window for the separation of media, comprising a separating disk transparent to the electromagnetic microwaves and at least one collet in the form of a circular cylindrical tube brazed via one of its edges onto one of the two faces of the disk, characterized in that the edge of the collet intended to be brazed onto one of the plane surfaces of the disk, and on which edge a thin film of active braze is deposited, has a generatrix close to a straight line.

Thus, in a preferred embodiment of this window according to the invention, the edge of a collet intended to be brazed onto the disk has the same width as the wall thickness of the tube.

In other embodiments, the microwave separating window comprises two coaxial collets in the form of circular cylindrical tubes that are brazed onto the disk in order to form a circuit for cooling the disk.

The invention will be more clearly understood with the aid of examples of embodiments of media-separating microwave windows according to the invention, with reference to the appended drawings in which:

FIG. 1, already described, is a drawing showing the principle of a very high-power gyrotron-type microwave tube of the prior art;

FIG. 2, already described, shows a separating window of the prior art, used in the gyrotron of FIG. 1;

FIGS. 3a and 3b, already described, show the offset that occurs between the collar and the bead prebrazed onto the disk;

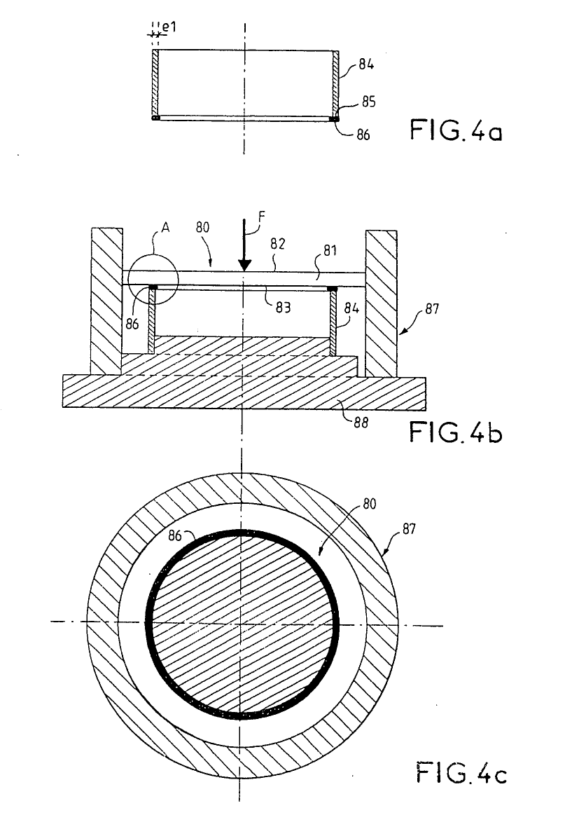

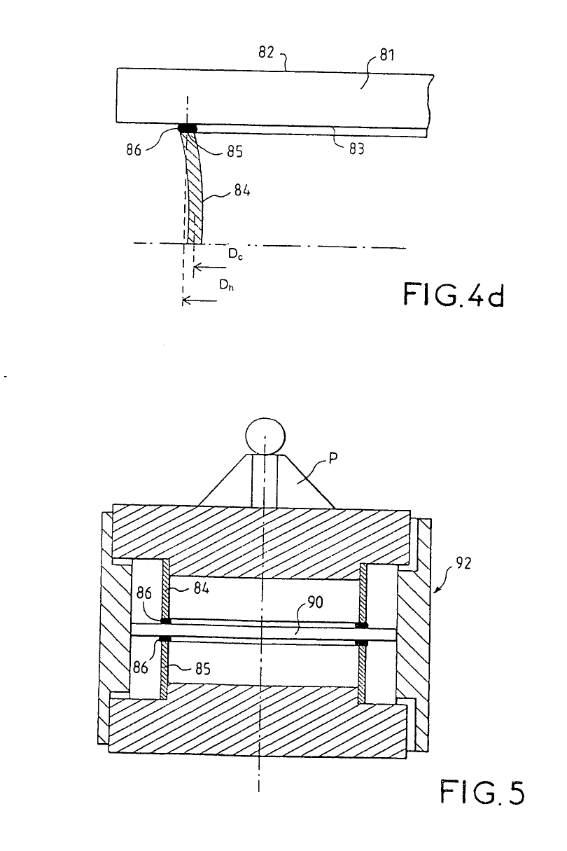

FIGS. 4a, 4b and 4c show steps of a process for manufacturing a separating window according to the invention;

FIG. 4d shows a partial view of a region where the collet is brazed onto the disk of the window shown in FIGS. 4b and 4c;

FIG. 5 shows the process according to the invention for manufacturing a window having a collet on each of the two faces of the separating disk;

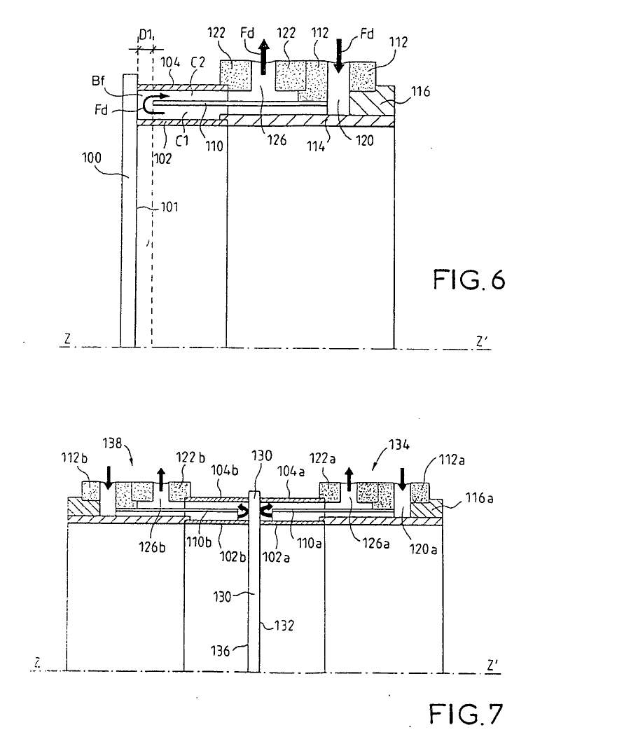

FIG. 6 represents a sectional view of a separating window according to the invention, which includes a cooling circuit;

FIG. 7 shows another embodiment of a window according to the invention, which includes a cooling circuit on each face of the disk of the window;

FIG. 8 represents a double-disk window comprising two windows according to the invention; and

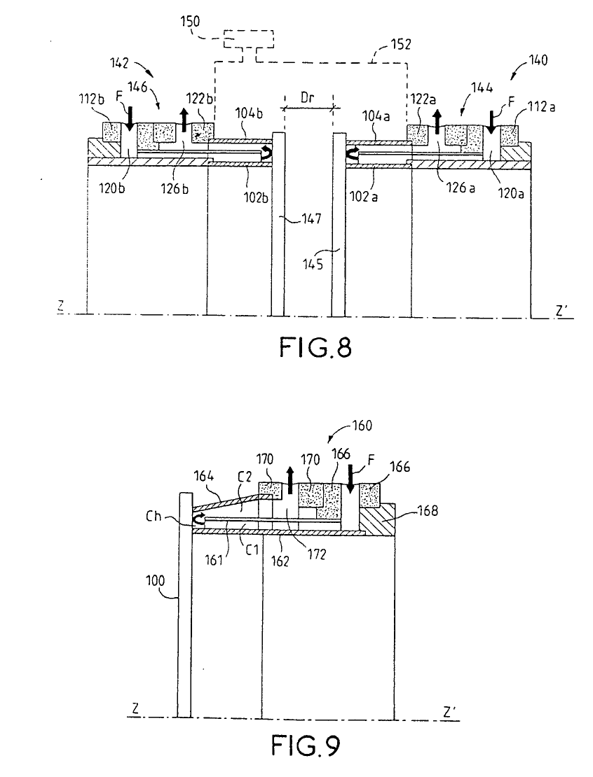

FIG. 9 shows another embodiment of the window according to the invention.

FIGS. 4a, 4b and 4c show steps in the manufacture of a separating window by the process according to the invention.

The window 80 essentially comprises a disk 81 made of synthetic diamond, having two substantially parallel main surfaces 82 and 83, and a copper collet 84 intended to be brazed onto a face 83 of the two main surfaces of the disk. The disk is made of diamond and the brazing is carried out at a high temperature of around 800° C.

In a first step, the collet 84 is produced in the form of a circular cylindrical tube with a wall thickness e1 and a tube diameter that are constant along the tube.

In a second step (FIG. 4a), a thin film of active braze 86 is deposited on the surface 85 of one of the edges of the collet 84 that is intended to be brazed onto the disk 81, said braze 86 being of the Cusin 1ABA type and melting at a high temperature of around 800° C.

The use of active braze makes it possible, in a known manner, to braze the collet 84 onto the surface 83 of the diamond disk in a single brazing operation.

In a third step (FIG. 4b), the collet 84 is applied, via its edge having the active braze 86, to the surface 83 of the disk using a centering tool 87, 88.

In a fourth step, the disk 81/collet 84/active braze 86 assembly is raised to a temperature of around 800° C., while applying a force F to compress the bead of active braze 86 between the edge of the collet and the surface of the disk, in order to braze the collet onto the disk, and then the window is cooled to room temperature.

The active braze is deposited by screen printing on the surface of one of the edges of the collet, that is intended to be brazed onto the disk.

FIG. 4c shows a top view of the disk and the collet that are guided in the centering tool.

FIG. 4d shows a partial view of a region A where the collet 84 is brazed onto the disk 81 of the window 80, resulting from the process according to the invention.

Before the brazing step, the collet when cold has a diameter D_{c}—this diameter is substantially constant along the edge of the tube in the region A.

During brazing, since the collet 84 and the disk 81 are raised to a temperature of around 800°, the collet expands and, when hot, its diameter increases to a diameter Dₕ. Since the brazing is carried out hot, the collet is brazed onto the surface of the disk when the hot collet has the diameter Dₕ. The difference between the hot diameter Dₕ and the cold diameter D_{c} may be of the order of the thickness of the edge of the tube.

Upon cooling, the braze bead fastened to the diamond disk, which expands very little, substantially retains its hot diameter, i.e. substantially the diameter Dₕ of the hot collet, whereas the collet 84 resumes its lower cold diameter D_{c}. When the window has cooled, the diameter of the cold collet D_{c} progressively increases on approaching the surface of the disk to become, at the brazed joint, its hot diameter Dₕ corresponding substantially to the diameter of the braze bead 86.

The advantage of the process according to the invention lies in the fact that the shape of the edge of the collet and the material of the collet allow flexible deformation of said edge by passing progressively from the diameter D_{c} to the diameter Dₕ of the brazed joint, producing much lower stresses between the disk and the collet for brazing temperatures, and therefore for window operating temperatures, that are higher than those of the brazing processes of the prior art.

FIG. 5 shows the process according to the invention for manufacturing a window, comprising a collet on each of the two faces of the separating disk.

For this purpose, two identical collets 84 and 85 are produced, active braze 86 being deposited on their respective edges intended to be brazed onto a disk 90. The disk 90 and the two collets 84 and 85 are mounted in a centering tool 92 in such a way that their respective edge having the active braze 86 is in contact with their respective face of the disk, and then they are brazed by raising the temperature in a vacuum furnace. A weight P on the centering device 92 presses the two collets 84, 85 against the two faces of the disk 90.

The collets are especially made of copper, this metal making it possible to limit the stresses between the collet and the disk that are due to the differences in cold diameters between that edge of the collet which is brazed onto the disk and the collet itself (FIG. 4d). The thickness of this collet is typically 1 mm.

In other embodiments, the microwave separating window is cooled by a cooling fluid; for this purpose, another operation consists in brazing the parts needed for the cooling circuit to the windows described above with one or two collets.

FIG. 6 shows a sectional view of a separating window according to the invention, which includes a cooling circuit.

The window of FIG. 6 comprises a cylindrical disk 100, with axis of revolution ZZ′, and two collets 102, 104 in the form of a circular cylindrical tube of constant diameter. The two collets 102,104 of different diameters are collinear with the ZZ′ axis of the disk.

In a first phase, the two collets are brazed by the process according to the invention described above, by depositing active braze metallization on the edges of the collets and then by brazing the collets onto one and the same surface 101 of the disk 100.

In a second phase, the elements needed to produce the cooling circuit are added to the window.

The cooling circuit comprises a stainless steel circular cylindrical separating tube 110 between the two copper collets 102, 104. The axis of revolution of the separating tube 110 is collinear with the ZZ′ axis of the disk.

The edge of the separating tube on the side facing the disk 100 is at a distance D1 from the disk, creating, with the two collets, an inlet compartment C1 on the side facing the smaller-diameter collet 102, an outlet compartment C2 on the side facing the larger-diameter collet 104 and a baffle Bf allowing a fluid Fd to flow from one compartment C1 to the other C2 via the baffle Bf.

The inlet compartment C1 is closed, on the side away from the baffle Bf, by a stainless steel inlet ring 112 fastened to the separating tube 110 and by another copper inlet collet 114, in the form of a tube whose axis is collinear with the ZZ′ axis, which is brazed by one of its ends onto the small-diameter collet 102. The inlet collet 114 comprises a copper closure ring 116 which is, on the one hand, fastened to the inlet ring 112 and is, on the other hand, brazed onto the free edge of the copper inlet collet 114.

The inlet ring 112 includes a duct 120 emerging in the inlet compartment C1 in order to allow cooling fluid Fd to flow into the cooling circuit C1, Bf, C2.

Furthermore, the outlet compartment C2 is closed, on the side away from the baffle Bf, by a stainless steel outlet ring 122, whose axis is collinear with the ZZ′ axis, which is fastened to the larger-diameter collet 104 and to the inlet ring 112. The outlet ring 122 includes a duct 126 emerging in the outlet compartment C2 in order to allow the cooling fluid to leave the cooling circuit C1, Bf, C2.

The cooling fluid, by flowing from the inlet compartment C1 via the baffle Bf to the outlet compartment C2, cools the various collets and that part of the disk lying between the two collets. Since the diamond disk is a very good heat conductor, this cooling region lying between the collets is sufficient to cool the disk 100.

FIG. 7 shows another embodiment of a window that includes a cooling circuit on each face of the disk of the window.

A disk 130 has, on the side facing one of its two main faces 132, a first cooling circuit 134 identical to the cooling circuit of FIG. 6 and, on the side facing the other face 136 of the disk, a second circuit 138 symmetrical with the first circuit 134. The first cooling circuit 134 bears the same reference numbers in the case of the same elements as those of the circuit shown in FIG. 6 together with the suffix “a” and those of the second cooling circuit 138 with the suffix “b”.

The disk 130 is then cooled via its two faces.

Another embodiment relates to an assembly for a double-disk window. Such double-disk windows are in the same way used for microwave tubes and transmission lines. For technical reasons, the two dielectric disks must be very close to each other (the distance Dr).

FIG. 8 shows such an assembly, which comprises a first window 140, identical to the window of FIG. 6 and having a separating disk 145, and a second window 142 symmetrical with the first with respect to a plane parallel to the faces of the disks of the two windows, the second window having another separating disk 147.

The two windows each have their respective cooling circuit, namely in the case of one of the windows, 140, a cooling circuit 144 on one side of one of the faces of its disk 145 and, in the case of the other window 142, another cooling circuit 146, symmetrical with the first 144, on one side of the other face of its disk 147.

A pumping device 150 creates a vacuum in a space bounded schematically by the wall 152 (in dotted lines) containing the two disks 145, 147 of the double-disk window.

The advantage of such an embodiment in FIG. 8, forming a double-disk window, lies in the fact that the two disks 145, 147 may be brought as close together as necessary, without being impeded by their respective cooling circuits, thereby making it possible to obtain satisfactory bandwidths of the microwave transmission circuit.

The shape of the collets, or of the cooling circuit, is not limited to the descriptions given by way of example. For reasons of compactness or efficiency, the length of the collets, their spacing and their shape may be varied.

For this purpose, FIG. 9 shows another embodiment of the window according to the invention, which includes a cooling circuit 1-60 of the same type as that of the window shown in FIG. 6.

The cooling circuit comprises a circular cylindrical separating tube 161 made of stainless steel lying between two copper collets 162, 164, of different diameters, the tubes and the collets, which are coaxial with the ZZ′ axis of the disk, creating the inlet compartment C1, the outlet compartment C2 and the baffle Bf for allowing the fluid Fd to flow from one compartment C1 to the other via the baffle Bf. The first collet 162 is in the form of a circular cylindrical tube and the second collet 164, which surrounds the first, is a copper tube of frustoconical shape, the smaller-diameter edge being brazed onto the disk 100.

The inlet compartment C1 is closed, on the side away from the baffle Bf, by a stainless steel inlet ring 166 fastened to the separating tube 161 and by a copper closure ring 168 brazed onto the free edge of the small-diameter collet 162.

The inlet ring 166 includes a conduit 168 that emerges in the inlet compartment C1 in order to allow cooling fluid to enter the cooling circuit C1, Bf, C2.

Furthermore, the outlet compartment C2 is closed, on the side away from the baffle Bf, by a stainless steel outlet ring 170, whose axis is collinear with the ZZ′ axis, fastened to the frustoconical collet 164 and to the inlet ring 166. The outlet ring 170 includes a conduit 172 emerging in the outlet compartment C2 in order to allow the cooling fluid to leave the cooling circuit C1, Bf, C2.

The process for brazing the microwave window according to the invention makes it possible to braze the collets onto the disk at much higher temperatures than those of the prior art. In this way, it is possible to produce windows that withstand much higher baking temperatures of around 500° C. The consequences for the microwave devices using such windows are a reduction in baking time and a time saving for conditioning the tube.

1. A method of manufacturing a microwave window for the separation of media including a separating disk transparent to the electromagnetic microwaves and at least one collet in the form of a circular cylindrical tube brazed via one of its edges onto one of the two faces of the disk, comprising:
at least one step of depositing a thin film of active braze on that edge of the collet which is intended to be brazed onto one of the two faces of the disk; and
brazing the tube onto the disk.

2. The method of manufacturing a microwave window as claimed in claim 1, wherein the edge of the collet intended to be brazed onto one of the plane faces of the disk has a generatrix close to a straight line.

3. The method of manufacturing a microwave window as claimed in claim 1: wherein:
in a first step, the collet is produced in the form of a circular cylindrical tube with a wall thickness and a tube diameter that are constant along the tube;
in a second step, a thin film of active braze is deposited on the surface of one of the edges of the collet that is intended to be brazed onto the disk, said braze being of the Cusin I ABA type and melting at a high temperature of around 800° C.;
in a third step, the collet is applied, via its edge having the active braze, to the surface of the disk using a centering tool; and
in a fourth step, the disk collet active braze assembly is raised to a temperature of around 800° C., while applying a force F to compress the bead of active braze between the edge of the collet and the surface of the disk, in order to braze the collet onto the disk, and then the window is cooled to room temperature.

4. The method of manufacturing a microwave window as claimed in claim 1 wherein the active braze is deposited by screen printing on the surface of one of the edges of the collet that is intended to be brazed onto the disk.

5. A microwave window for the separation of media, comprising:
a separating disk transparent to the electromagnetic microwaves and at least one collet in the form of a circular cylindrical tube brazed via one of its edges onto one of the two faces of the disk, wherein the edge of the collet intended to be brazed into one of the plane surfaces of the disk, and on which edge a thin film of active braze is deposited, has a generatrix close to a straight line.

6. The microwave window as claimed in claim 5, wherein the edge of a collet intended to be brazed onto the disk has the same width as the wall thickness of the tube.

7. The microwave window as claimed in claim 5, wherein it comprises two coaxial collets in the form of circular cylindrical tubes that are brazed onto the disk in order to form a circuit for cooling the disk.

8. The microwave window as claimed in claim 7, wherein the cooling circuit comprises a stainless steel separating tube having a diameter between the two diameters of the copper collets, the separating tube, whose axis of revolution is collinear with the ZZ′ axis of the disk, being located between the two collets the edge of the separating tube on the side facing the disk being at a distance from the disk, creating, with the two collets, an inlet compartment on the side facing the smaller-diameter collet, an outlet compartment on the side facing the larger-diameter collet and a baffle allowing a fluid Fd to flow from one compartment to the other via the baffle.

9. The microwave window as claimed in claim 8, wherein the inlet compartment is closed, on the side away from the baffle, by a stainless steel inlet ring fastened to the separating tube and by another inlet collet made of copper, in the form of a tube whose axis is collinear with the ZZ′ axis, said tube being brazed via one of its ends onto the small-diameter collet, the inlet collet having a copper closure ring which is, on the one hand, fastened to the inlet ring and, on the other hand, brazed onto the free edge of the copper inlet collet, the inlet ring includes a duct emerging in the inlet compartment in order to allow cooling fluid to flow into the cooling circuit, the outlet compartment being closed, on the side away from the baffle, by a stainless steel outlet ring whose axis is collinear with the ZZ′ axis, which is fastened to the larger-diameter collet and to the inlet ring, the outlet ring having a duct emerging in the outlet compartment in order to allow the cooling fluid to leave the cooling circuit.

10. The microwave window as claimed in claim 5, wherein it includes a cooling circuit comprising a circular cylindrical separating tube made of stainless steel lying between two copper collets of different diameters, the tubes and the collets, which are coaxial with the ZZ′ axis of the disk, creating the inlet compartment, the outlet compartment and the baffle Bf for allowing the fluid Fd to flow from one compartment to the other via the baffle Bf, the first collet being in the from of a circular cylindrical tube, the second collet, which surrounds the first, being a copper tube of frustoconical shape, the smaller-diameter edge being brazed onto the disk, the inlet compartment being closed, on the side away from the baffle, by a stainless steel inlet ring fastened to the separating tube and by a copper closure ring brazed onto the free edge of the small-diameter collet, the inlet ring having a conduit that emerges in the inlet compartment in order to allow the cooling fluid to enter the cooling circuit, the outlet compartment being closed, on the side away from the baffle, by a stainless steel outlet ring, whose axis is collinear with the ZZ′ axis, fastened to the frustoconical collet and to the inlet ring, the outlet ring having a conduit emerging in the outlet compartment in order to allow the cooling fluid to leave the cooling circuit.

11. A double-disk microwave window, wherein it comprises a first window having a separating disk and a second window, symmetrical with the first, having another separating window as claimed in claim 5, the first and second window being symmetrical with respect to a plane parallel to the faces of the disks of the two windows, the two windows each having their respective cooling circuit, in the case of one of the windows, a cooling circuit on the same side as one of the faces of its disk and in the case of the other window another cooling circuit, symmetrical with the first, on the same side as the other face of its disk, a pumping device creating a vacuum in a space bounded by a wall, comprising the two disks of the double-disk window.

12. The method of manufacturing a microwave window as claimed in claim 2 wherein:
in a first step, the collet is produced in the form of a circular cylindrical tube with a wall thickness and a tube diameter that are constant along the tube;
in a second step, a thin film of active braze is deposited on the surface of one of the edges of the collet that is intended to be brazed onto the disk, said braze being of the Cusin 1ABA type and melting at a high temperature of around 800° C.;
in a third step, the collet is applied, via its edge having the active braze, to the surface] of the disk using a centering tool; and
in a fourth step, the disk collet active braze assembly is raised to a temperature of around 800° C., while applying a force F to compress the bead of active braze between the edge of the collet and the surface of the disk, in order to braze the collet onto the disk, and then the window is cooled to room temperature.

13. The method of manufacturing a microwave window as claimed in claim 2, wherein the active braze is deposited by screen printing on the surface of one of the edges of the collet that is intended to be brazed onto the disk.

14. The method of manufacturing a microwave window as claimed in claim 3, wherein the active braze is deposited by screen printing on the surface of one of the edges of the collet that is intended to be brazed onto the disk.

15. The microwave window as claimed in claim 6, wherein it comprises two coaxial collets in the form of circular cylindrical tubes that are brazed onto the disk in order to form a circuit for cooling the disk.

16. The microwave window as claimed in claim 6, wherein it includes a cooling circuit comprising a circular cylindrical separating tube made of stainless steel lying between two copper collets of different diameters, the tubes and the collets, which are coaxial with the ZZ′ axis of the disk, creating the inlet compartment, the outlet compartment and the baffle Bf for allowing the fluid Fd to flow from one compartment to the other via the baffle Bf, the first collet being in the form of a circular cylindrical tube, the second collet, which surrounds the first, being a copper tube of frustoconical shape, the smaller-diameter edge being brazed onto the disk, the inlet compartment being closed, on the side away from the baffle, by a stainless steel inlet ring fastened to the separating tube and by a copper closure ring brazed onto the free edge of the small-diameter collet, the inlet ring having a conduit that emerges in the inlet compartment in order to allow the cooling fluid to enter the cooling circuit, the outlet compartment being closed, on the side away from the baffle, by a stainless steel outlet ring, whose axis is collinear with the ZZ′ axis, fastened to the frustoconical collet and to the inlet ring, the outlet ring having a conduit emerging in the outlet compartment in order to allow the cooling fluid to leave the cooling circuit.

17. A double-disk microwave window, wherein it comprises a first window having a separating disk and a second window, symmetrical with the first, having another separating window as claimed in claim 6, the first and second window being symmetrical with respect to a plane parallel to the faces of the disks of the two windows, the two windows each having their respective cooling circuit, in the case of one of the windows, a cooling circuit oil the same side as one of the faces of its disk and in the case of the other window another cooling circuit symmetrical with the first, on the same side as the other face of its disk, a pumping device creating a vacuum in a space bounded by a wall, comprising the two disks of the double-disk window.

18. A double-disk microwave window, wherein it comprises a first window having a separating disk and a second window, symmetrical with the first, having another separating window as claimed in claim 7, the first and second window being symmetrical with respect to a plane parallel to the faces of the disks of the two windows, the two windows each having their respective cooling circuit, in the case of one of the windows, a cooling circuit on the same side as one of the faces of its disk and in the case of the other window another cooling circuit symmetrical with the first, on the same side as the other face of its disk, a pumping device creating a vacuum in a space bounded by a wall, comprising the two disks of the double-disk window.

19. A double-disk microwave window, wherein it comprises a first window having a separating disk and a second window, symmetrical with the first, having another separating window as claimed in claim 8, the first and second window being symmetrical with respect to a plane parallel to the faces of the disks of the two windows, the two windows each having their respective cooling circuit, in the case of one of the windows, a cooling circuit on the same side as one of the faces of its disk and in the case of the other window another cooling circuit symmetrical with the first, on the same side as the other face of its disk, a pumping device creating a vacuum in a space bounded by a wall, comprising the two disks of the double-disk window.

20. A double-disk microwave window, wherein it comprises a first window having a separating disk and a second window, symmetrical with the first, having another separating window as claimed in claim 9, the first and second window being symmetrical with respect to a plane parallel to the faces of the disks of the two windows, the two windows each having their respective cooling circuit, in the case of one of the windows a cooling circuit on the same side as one of the faces of its disk and in the case of the other window another cooling circuit symmetrical with the first, on the same side as the other face of its disk, a pumping device creating a vacuum in a space bounded by a wall, comprising the two disks of the double-disk window.

21. A double-disk microwave window, wherein it comprises a first window having a separating disk and a second window, symmetrical with the first, having another separating window as claimed in claim 10, the first and second window being symmetrical with respect to a plane parallel to the faces of the disks of the two windows, the two windows each having their respective cooling circuit, in the case of one of the windows, a cooling circuit on the same side as one of the faces of its disk and in the case of the other window another cooling circuit symmetrical with the first, on the same side as the other face of its disk, a pumping device creating a vacuum in a space bounded by a wall, comprising the two disks of the double-disk window.
